(19) United States
(12) Patent Application Publication
(10) Pub. No.: US 2026/0136413 A1
(43) Pub. Date: May 14, 2026

(54) AUDIO SWITCHING SYSTEM AND METHOD

(71) Applicant: YEALINK (XIAMEN) NETWORK TECHNOLOGY CO., LTD., Xiamen (CN)

(72) Inventor: Jinhong Chen, Xiamen (CN)

(21) Appl. No.: 19/437,395

(22) Filed: Dec. 31, 2025

Related U.S. Application Data
(63) Continuation-in-part of application No. PCT/CN2025/072385, filed on Jan. 15, 2025.

(30) Foreign Application Priority Data
Jan. 17, 2024 (CN) 202410069603.0

(51) Int. Cl. H04W 76/14; G06F 3/16

(52) U.S. Cl. CPC H04W 76/14; G06F 3/162

(57) ABSTRACT

The present application relates to an audio switching system and method. The system includes at least two audio receiving devices and an audio transmitting device, where each audio receiving device in the audio switching system is in either of two states of being a target audio receiving device and being a non-target audio receiving device. When the target audio receiving device performs audio transmission with the audio transmitting device through bidirectional Bluetooth connection, the non-target audio receiving device monitors audio data transmitted by the audio transmitting device to the target audio receiving device, and receives connection information of the target audio receiving device and the audio transmitting device. In response to detecting an audio switching operation, an audio receiving device switches its state to the other state different from the current state of being the target audio receiving device or the non-target audio receiving device.

### CROSS-REFERENCE TO RELATED APPLICATION

This application is a continuation-in-part of PCT Application No. PCT/CN2025/072385, filed on January 15, 2025. This application claims priority to Chinese Patent Application 202410069603.0, filed with the China National Intellectual Property Administration (CNIPA) on January 17, 2024 and entitled "AUDIO SWITCHING SYSTEM AND METHOD". Both of the foregoing applications are incorporated herein by reference in their entireties.

### TECHNICAL FIELD

The present disclosure relates generally to audio communication systems and, more particularly, to an audio switching system and method.

### BACKGROUND

At present, a combination of a Bluetooth headphone and a base is becoming increasingly popular in a high-end personal office field on the market. There is increasingly prevalent demand for linkage among devices such as a headphone, the base, and a mobile phone, as well as for free switching of calls and music sound channels. In the field of audio device configuration, existing art include establishing a plurality of connections by using a single Bluetooth chip, processing different connections by using two Bluetooth chips, and forwarding a private instruction via Bluetooth. Some technical solutions adopt two Bluetooth chips on the base to respectively process a connection between the base and the headphone and a connection between the base and the mobile phone. Some technical solutions establish a Bluetooth connection between every two among the base, the headphone, and the mobile phone, with a single Bluetooth chip used on the base to forward a private notification instruction. Some technical solutions employ a single Bluetooth chip on the base to establish two extended synchronous connection-oriented (eSCO)/advanced audio distribution profile (A2DP) links simultaneously.

### SUMMARY

In some embodiments, the present disclosure provide an audio switching system, including: at least two audio receiving devices and an audio transmitting device. In a case that an audio receiving device establishes a bidirectional Bluetooth connection with another audio receiving device and the audio transmitting device, the audio receiving device is in either of two states of being a target audio receiving device and being a non-target audio receiving device. The target audio receiving device performs audio transmission with the audio transmitting device through bidirectional Bluetooth connection, where the target audio receiving device is an audio receiving device that currently establishes bidirectional Bluetooth connection with the audio transmitting device. The non-target audio receiving device monitors, by using a preset monitoring technology, audio data transmitted by the audio transmitting device to the target audio receiving device, and receives, through bidirectional Bluetooth connection, connection information for establishing bidirectional Bluetooth connection between the target audio receiving device and the audio transmitting device, where the non-target audio receiving device is an audio receiving device that does not currently establish bidirectional Bluetooth connection with the audio transmitting device. In response to detecting an audio switching operation, the audio receiving device switches a state of the audio receiving device to the other state different from the current state of being the target audio receiving device or the non-target audio receiving device.

In some embodiments of the present disclosure further provide an audio switching method, applicable to a target audio receiving device in an audio switching system, where the audio switching method includes: in response to detecting an audio switching operation, generating an audio switching instruction, and transmitting the audio switching instruction to a non-target audio receiving device, whereby the non-target audio receiving device is changed to a new target audio receiving device and performs audio transmission with an audio transmitting device through bidirectional Bluetooth connection; changing to a new non-target audio receiving device, switching to a monitoring mode, and monitoring, by using a preset monitoring technology, audio data transmitted by the audio transmitting device to the new target audio receiving device; and receiving, through bidirectional Bluetooth connection, connection information for establishing bidirectional Bluetooth connection between the new target audio receiving device and the audio transmitting device.

In some embodiments of the present disclosure further provide an audio switching apparatus, applicable to a target audio receiving device in an audio switching system, including: a first switching module configured to: in response to detecting an audio switching operation, generate an audio switching instruction, and transmit the audio switching instruction to a non-target audio receiving device, whereby the non-target audio receiving device is changed to a new target audio receiving device and performs audio transmission with an audio transmitting device through bidirectional Bluetooth connection; a device monitoring module configured to change to a new non-target audio receiving device, switch to a monitoring mode, and monitor, by using a preset monitoring technology, audio data transmitted by the audio transmitting device to the new target audio receiving device; and a first information synchronization module configured to receive, through bidirectional Bluetooth connection, connection information for establishing bidirectional Bluetooth connection between the new target audio receiving device and the audio transmitting device.

### BRIEF DESCRIPTION OF THE DRAWINGS

FIG. 1 is a schematic diagram of an architecture of an audio switching system according to some embodiments of the present disclosure;

FIG. 2 is a schematic flowchart of an audio switching method according to some embodiments of the present disclosure;

FIG. 3 is a first schematic connection diagram of an existing art according to some embodiments of the present disclosure;

FIG. 4 is a first schematic switching diagram of an existing art according to some embodiments of the present disclosure;

FIG. 5 is a second schematic connection diagram of an existing art according to some embodiments of the present disclosure;

FIG. 6 is a second schematic switching diagram of an existing art according to some embodiments of the present disclosure;

FIG. 7 is a first schematic connection diagram of an audio switching system according to some embodiments of the present disclosure;

FIG. 8 is a second schematic connection diagram of an audio switching system according to some embodiments of the present disclosure;

FIG. 9 is a schematic diagram of switching logic according to some embodiments of the present disclosure;

FIG. 10 is a first schematic structural diagram of an audio switching apparatus according to some embodiments of the present disclosure; and

FIG. 11 is a second schematic structural diagram of an audio switching apparatus according to some embodiments of the present disclosure.

### DETAILED DESCRIPTION

The technical solutions in the embodiments of the present disclosure are clearly and completely described below with reference to the accompanying drawings in the embodiments of the present disclosure. Apparently, the described embodiments are only some rather than all of the embodiments of the present disclosure. All other embodiments derived from the embodiments of the present disclosure by a person of ordinary skill in the art without creative efforts shall fall within the protection scope of the present disclosure.

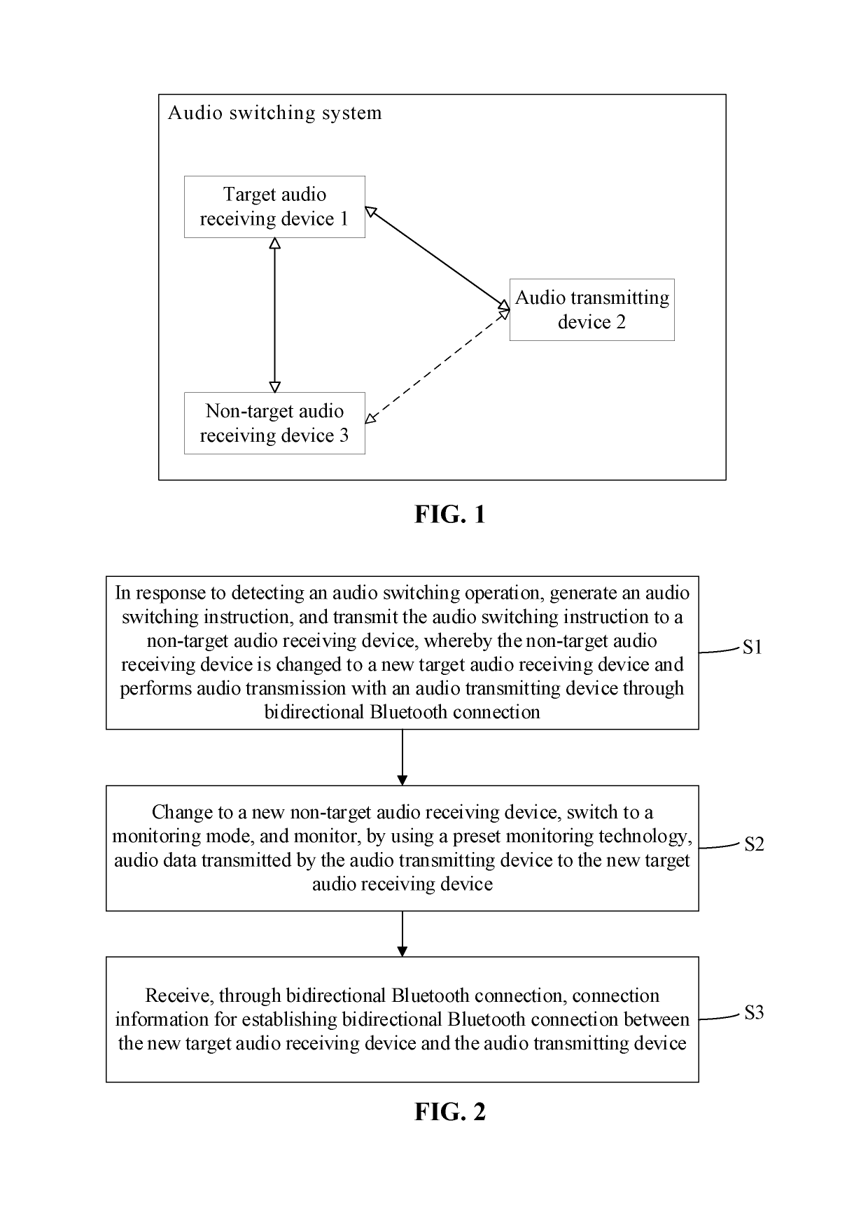

FIG. 1 is a schematic diagram of an architecture of an audio switching system according to some embodiments of the present disclosure. The audio switching system includes at least two audio receiving devices and an audio transmitting device. When an audio receiving device establishes a bidirectional Bluetooth connection with another audio receiving device and the audio transmitting device, the audio receiving device is in either of two states of being a target audio receiving device and being a non-target audio receiving device. The target audio receiving device 1 performs audio transmission with the audio transmitting device 2 through bidirectional Bluetooth connection, where the target audio receiving device 1 is an audio receiving device that currently establishes bidirectional Bluetooth connection with the audio transmitting device 2. The non-target audio receiving device 3 monitors, by using a preset monitoring technology, audio data transmitted by the audio transmitting device 2 to the target audio receiving device 1, and receives, through bidirectional Bluetooth connection, connection information for establishing bidirectional Bluetooth connection between the target audio receiving device 1 and the audio transmitting device 2, where the non-target audio receiving device is an audio receiving device that does not currently establish bidirectional Bluetooth connection with the audio transmitting device. The audio receiving device switches, in response to detecting an audio switching operation, its state to the other state different from the current state of being the target audio receiving device or the non-target audio receiving device.

In the present disclosure, in response to detecting the audio switching operation, the audio receiving device switches its state to the other state different from the current state of being the target audio receiving device or the non-target audio receiving device, and there is no need to interrupt a connection, forward a private notification instruction, and then establish a connection. Therefore, there will be no disconnection abnormality or connection failure. Additionally, there is no need to forward the audio data or establish two audio communication connections, so there will be no unstable connection, easy disconnection, or shortened communication distance during audio data forwarding, and thus no increase in data communication packet loss. Meanwhile, the target audio receiving device and the non-target audio receiving device simultaneously receive data sent by the audio transmitting device, and communication data between the target audio receiving device and the audio transmitting device can be synchronized to the non-target audio receiving device. This ensures synchronization between communication timeslots of the audio transmitting device and the audio transmitting device and eliminates a delay in an audio switching process.

In some embodiments, , the at least two audio receiving devices are respectively a base and a headphone; and the audio transmitting device is a mobile phone. The audio receiving device is a device that receives a Bluetooth call or music audio, and the audio receiving device needs to have a monitoring mode. The audio transmitting device is a device that provides the Bluetooth call or the music audio. Devices paired with the base and the headphone are not limited to the mobile phone, and can also include a personal computer (PC), a telephone, a tablet, and other devices that provide the Bluetooth call or the music audio, that is, the base and the headphone may be combined with the mobile phone, the PC, the telephone, or the tablet. Devices paired with the mobile phone are not limited to a combination of the base and the headphone, but can also be two headphones, two bases, or other devices that receive the Bluetooth call or the music audio. In other words, when the base is paired with the headphone, the headphone may be replaced by the telephone, a handset, or another base, and the base may be replaced by the telephone, the handset, or another headphone, provided that the devices used to replace the base and the headphone have the monitoring mode. In the present disclosure, the base is a base station used in pairing with the headphone. For example, in an office scenario, the base may be a desktop audio dock/base device, which is typically placed on a desk and paired with a wireless headphone. It can support a user to manually trigger the audio switching operation, generate an audio switching instruction, and negotiate role switching with the headphone, achieving seamless switching of an audio channel between the mobile phone and the base and between the mobile phone and the headphone.

In some embodiments of the present disclosure, that the audio receiving device switches, in response to detecting an audio switching operation, its state to the other state different from the current state of being the target audio receiving device 1 or the non-target audio receiving device 3 includes: generating the audio switching instruction, and transmitting the audio switching instruction to the non-target audio receiving device 3, whereby the non-target audio receiving device 3 is changed to a new target audio receiving device and performs audio transmission with the audio transmitting device 2 through bidirectional Bluetooth connection; changing the target audio receiving device 1 to a new non-target audio receiving device, switching to the monitoring mode, and monitoring, by using the preset monitoring technology, audio data transmitted by the audio transmitting device 2 to the new target audio receiving device; and receiving, through bidirectional Bluetooth connection, connection information for establishing bidirectional Bluetooth connection between the new target audio receiving device and the audio transmitting device 2.

In some embodiments of the present disclosure, when the one audio receiving device establishes the bidirectional Bluetooth connection with the another audio receiving device and the audio transmitting device, when receiving the audio switching instruction transmitted by the non-target audio receiving device, the target audio receiving device is further changed to the new non-target audio receiving device, switches to the monitoring mode, monitors, by using the preset monitoring technology, the audio data transmitted by the audio transmitting device to the new target audio receiving device, and receives, through bidirectional Bluetooth connection, the connection information for establishing bidirectional Bluetooth connection between the new target audio receiving device and the audio transmitting device. In response to detecting the audio switching operation, the non-target audio receiving device is changed to the new target audio receiving device, generates the audio switching instruction, and performs the audio transmission with the audio transmitting device through bidirectional Bluetooth connection.

In some implementations, the audio receiving device can also send data, and the audio transmitting device can also receive data. The audio receiving device can send the data when communicating with the audio transmitting device as the target audio receiving device. The audio transmitting device can receive the data when communicating with the target audio receiving device. There is a process of information exchange between the audio transmitting device and the target audio receiving device. For example, when a user speaks into the target audio receiving device, the target audio receiving device sends audio data to the audio transmitting device, and the audio transmitting device receives the audio data. The target audio receiving device and the audio transmitting device perform information exchange, in other words, the target audio receiving device and the audio transmitting device communicate with each other. In addition, the audio data sent by the target audio receiving device to the audio transmitting device is real-time. This is equivalent to that the user speaks using the target audio receiving device, the target audio receiving device ends current data transmission after sending current audio data to the audio transmitting device. After an audio mode is switched, the target audio receiving device no longer sends audio data. The data sent and received by the audio receiving device and the audio transmitting device not only includes the audio data, but also includes other control data. When the one audio receiving device establishes bidirectional Bluetooth connection with the another audio receiving device, and one of these two audio receiving devices establishes bidirectional Bluetooth connection with the audio transmitting device, the target audio receiving device and the audio transmitting device perform the audio transmission through bidirectional Bluetooth connection. Herein, the target audio receiving device is an audio receiving device that currently establishes bidirectional Bluetooth connection with the audio transmitting device. At this time, call audio and music audio on the audio transmitting device are played on the target audio receiving device, and data of the target audio receiving device is also sent to the audio transmitting device, whereby the target audio receiving device is connected to the audio transmitting device for making a call and listening to music. When the target audio receiving device establishes bidirectional Bluetooth connection with the audio transmitting device, the non-target audio receiving device monitors data transmitted by the audio transmitting device to the target audio receiving device. Herein, the non-target audio receiving device is the audio receiving device that does not currently establish bidirectional Bluetooth connection with the audio transmitting device. As shown in FIG. 7, when the target audio receiving device is the base, the non-target audio receiving device is the headphone, and the audio transmitting device is the mobile phone, the base and the mobile phone perform the audio transmission through bidirectional Bluetooth connection, whereby the call audio and the music audio on the mobile phone are played on the base. The data of the base is transmitted to the mobile phone, whereby the base is connected to the mobile phone for making the call and listening to the music. At this time, the headphone monitors the data transmitted by the mobile phone to the base, and synchronously receives, through bidirectional Bluetooth connection between the base and the headphone, the connection information for establishing bidirectional Bluetooth connection between the base and the mobile phone. When the target audio receiving device is the headphone, the non-target audio receiving device is the base, and the audio transmitting device is the mobile phone, the headphone and the mobile phone perform the audio transmission through bidirectional Bluetooth connection, whereby the call audio and the music audio on the mobile phone are played on the headphone. The data of the headphone is transmitted to the mobile phone, whereby the headphone is connected to the mobile phone for making the call and listening to the music. At this time, the base monitors the data transmitted by the mobile phone to the headphone, and synchronously receives, through bidirectional Bluetooth connection between the headphone and the base, the connection information for establishing bidirectional Bluetooth connection between the headphone and the mobile phone.

In some implementations, a communication protocol for the audio switching instruction between the base and the headphone may be based on a standard Bluetooth protocol or a private protocol. In response to detecting the audio switching operation, the target audio receiving device generates the audio switching instruction, and transmits the audio switching instruction to the non-target audio receiving device, whereby the non-target audio receiving device is changed to the new target audio receiving device and performs the audio transmission with the audio transmitting device through bidirectional Bluetooth connection. In addition, the target audio receiving device is changed to the new non-target audio receiving device, switches to the monitoring mode, monitors, by using the preset monitoring technology, data transmitted by the audio transmitting device to the new target audio receiving device, and receives, through bidirectional Bluetooth connection to the new target audio receiving device, the connection information for establishing bidirectional Bluetooth connection between the new target audio receiving device and the audio transmitting device. As shown in FIG. 7 and FIG. 8, when the target audio receiving device is the base, the non-target audio receiving device is the headphone, and the audio transmitting device is the mobile phone, in response to detecting the audio switching operation, the base generates the audio switching instruction and transmits the audio switching instruction to the headphone, whereby the headphone performs the audio transmission with the mobile phone through bidirectional Bluetooth connection. Meanwhile, the base switches to the monitoring mode, monitors, by using the preset monitoring technology, the data transmitted by the mobile phone to the headphone, and receives, through bidirectional Bluetooth connection between the base and the headphone, the connection information for establishing bidirectional Bluetooth connection between the headphone and the mobile phone. Therefore, a connection mode shown in FIG. 7 is switched to a connection mode shown in FIG. 8. When the target audio receiving device is the headphone, the non-target audio receiving device is the base, and the audio transmitting device is the mobile phone, in response to detecting the audio switching operation, the headphone generates the audio switching instruction and transmits the audio switching instruction to the base, whereby the headphone performs the audio transmission with the mobile phone through bidirectional Bluetooth connection. Meanwhile, the headphone switches to the monitoring mode, monitors, by using the preset monitoring technology, the data transmitted by the mobile phone to the base, and receives, through bidirectional Bluetooth connection between the headphone and the base, the connection information for establishing bidirectional Bluetooth connection between the base and the mobile phone. Therefore, the connection mode shown in FIG. 8 is switched to the connection mode shown in FIG. 7.

In some embodiments of the present disclosure, the audio transmission between the audio receiving device and the audio transmitting device may be implemented by using a standard eSCO protocol, a synchronous connect-oriented (SCO) protocol, a low energy audio (LE Audio) protocol, or another private protocol. When the one audio receiving device establishes the bidirectional Bluetooth connection with the another audio receiving device and the audio transmitting device, when receiving the audio switching instruction transmitted by the non-target audio receiving device, the target audio receiving device is further changed to the new non-target audio receiving device, switches to the monitoring mode, monitors, by using the preset monitoring technology, the data transmitted by the audio transmitting device to the new target audio receiving device, and receives, through bidirectional Bluetooth connection, the connection information for establishing bidirectional Bluetooth connection between the new target audio receiving device and the audio transmitting device. In response to detecting the audio switching operation, the non-target audio receiving device is changed to the new target audio receiving device, generates the audio switching instruction, and performs the audio transmission with the audio transmitting device through bidirectional Bluetooth connection. When the target audio receiving device is the base, the non-target audio receiving device is the headphone, and the audio transmitting device is the mobile phone, when receiving the audio switching instruction transmitted by the headphone, the base further switches to the monitoring mode, monitors, by using the preset monitoring technology, the data transmitted by the mobile phone to the headphone, and receives, through bidirectional Bluetooth connection between the base and the headphone, the connection information for establishing bidirectional Bluetooth connection between the headphone and the mobile phone. In response to detecting the audio switching operation, the headphone generates the audio switching instruction, and performs the audio transmission with the mobile phone through bidirectional Bluetooth connection. When the target audio receiving device is the headphone, the non-target audio receiving device is the base, and the audio transmitting device is the mobile phone, when receiving the audio switching instruction transmitted by the base, the headphone further switches to the monitoring mode, monitors, by using the preset monitoring technology, the data transmitted by the mobile phone to the base, and receives, through bidirectional Bluetooth connection between the headphone and the base, the connection information for establishing bidirectional Bluetooth connection between the base and the mobile phone. In response to detecting the audio switching operation, the base generates the audio switching instruction, and performs the audio transmission with the mobile phone through bidirectional Bluetooth connection.

In some embodiments of the present disclosure, the one audio receiving device establishes the bidirectional Bluetooth connection with the another audio receiving device and the audio transmitting device, and a connection mode of bidirectional Bluetooth connection includes any one and a combination of a basic rate/enhanced data rate (BR/EDR) connection (traditional Bluetooth connection) and a Bluetooth low energy (BLE) connection. When the one audio receiving device establishes the bidirectional Bluetooth connection with the another audio receiving device and the audio transmitting device, the target audio receiving device performs the audio transmission with the audio transmitting device through the BR/EDR connection, the BLE connection, or a combination of the BR/EDR connection and the BLE connection (the target audio receiving device is the audio receiving device that currently establishes bidirectional Bluetooth connection with the audio transmitting device). The non-target audio receiving device establishes the BR/EDR connection, the BLE connection, or the combination of the BR/EDR connection and the BLE connection to the target audio receiving device to receive the connection information for establishing bidirectional Bluetooth connection between the target audio receiving device and the audio transmitting device (the non-target audio receiving device is the audio receiving device that does not currently establish bidirectional Bluetooth connection with the audio transmitting device). As shown in FIG. 7, the connection mode between the base and the mobile phone may be the BR/EDR connection, the BLE connection, or the combination of the BR/EDR connection and the BLE connection. The connection mode between the base and the headphone may be the BR/EDR connection, the BLE connection, or the combination of the BR/EDR connection and the BLE connection. That is, when the connection mode between the base and the mobile phone is one of the BR/EDR connection, the BLE connection, or the combination of the BR/EDR connection and the BLE connection, the connection mode between the base and the headphone may be the BR/EDR connection, the BLE connection, or the combination of the BR/EDR connection and the BLE connection. As shown in FIG. 8, the connection mode between the headphone and the mobile phone may be the BR/EDR connection, the BLE connection, or the combination of the BR/EDR connection and the BLE connection. The connection mode between the headphone and the base may be the BR/EDR connection, the BLE connection, or the combination of the BR/EDR connection and the BLE connection. That is, when the connection mode between the headphone and the mobile phone is one of the BR/EDR connection, the BLE connection, or the combination of the BR/EDR connection and the BLE connection, the connection mode between the headphone and the base may be the BR/EDR connection, the BLE connection, or the combination of the BR/EDR connection and the BLE connection. Currently, the BR/EDR connection is commonly used. However, other connection modes can also be chosen based on actual needs.

In some implementations, when the one audio receiving device establishes the bidirectional Bluetooth connection with the another audio receiving device and the audio transmitting device, the target audio receiving device is the audio receiving device that currently establishes bidirectional Bluetooth connection with the audio transmitting device, and the non-target audio receiving device is the audio receiving device that does not currently establish bidirectional Bluetooth connection with the audio transmitting device. By using the preset monitoring technology, the non-target audio receiving device monitors the audio data transmitted by the audio transmitting device to the target audio receiving device. The preset monitoring technology includes a TrueWireless Mirroring technology, a multi-channel synchronization (MCSync) technology, or another private monitoring technology. When the target audio receiving device is the base, the non-target audio receiving device is the headphone, and the audio transmitting device is the mobile phone, the headphone monitors, by using the preset monitoring technology, the audio data transmitted by the mobile phone to the base. When the target audio receiving device is the headphone, the non-target audio receiving device is the base, and the audio transmitting device is the mobile phone, the base monitors, by using the preset monitoring technology, the audio data transmitted by the mobile phone to the headphone.

In some embodiments of the present disclosure, the audio transmitting device performs the audio transmission with the target audio receiving device through bidirectional Bluetooth connection, and the audio data transmitted by the audio transmitting device to the target audio receiving device is monitored by the non-target audio receiving device. The connection information for establishing bidirectional Bluetooth connection between the target audio receiving device and the audio transmitting device is transmitted to the non-target audio receiving device through bidirectional Bluetooth connection between the target audio receiving device and the non-target audio receiving device. When the original target audio receiving device is changed to the new non-target audio receiving device, and the original non-target audio receiving device is changed to the new target audio receiving device, the audio transmitting device performs audio data transmission with the new target audio receiving device through bidirectional Bluetooth connection. That is, the data sent by the audio transmitting device is responded to by the new target audio receiving device. When the two audio receiving devices are the base and the headphone, and the audio transmitting device is the mobile phone, the mobile phone performs the audio transmission with the base through bidirectional Bluetooth connection, and the audio data transmitted by the mobile phone to the base is monitored by the headphone. When the switching operation occurs, the mobile phone performs the audio transmission with the headphone through bidirectional Bluetooth connection, and the audio data transmitted by the mobile phone to the headphone is monitored by the base.

In some embodiments of the present disclosure, in the connection mode shown in FIG. 7, the base establishes bidirectional BR/EDR Bluetooth connection with the mobile phone, and also establishes a bidirectional BR/EDR Bluetooth connection to the headphone. The base is equipped with a single Bluetooth chip, and the headphone is also equipped with a Bluetooth chip. In this connection mode, the base communicates with the mobile phone for data transmission, and the headphone monitors, through a monitoring path 1 (a dotted-line path in FIG. 7), information sent by the mobile phone to the base, and also receives the connection information that is used for establishing bidirectional Bluetooth connection between the base and the mobile phone and synchronized through the bidirectional BR/EDR Bluetooth connection between the headphone and the base. When the user needs to switch to the connection mode shown in FIG. 8 (needs to switch the base to the headphone to play mobile phone audio and make or receive a call), the user operates on the base or the headphone to trigger mode switching. Then the base and the headphone communicate with each other to transmit the audio switching instruction. The audio switching instruction is merely used to negotiate who serves as an agent. A device that serves as the agent responds to a message from the mobile phone. Based on a side that triggers the mode switching operation, the base and the headphone transfer the audio switching instruction to the other side. The negotiation between the base and the headphone may be implemented through communication of any form. Based on switching to an audio transmission mode or the monitoring mode, the base and the headphone determine who should respond to the message from the mobile phone (in the monitoring mode, the message from the mobile phone is not responded to). In fact, the mobile phone itself does not receive the audio switching instruction. From a perspective of the mobile phone, the mobile phone does not know existence of the base and the headphone. The base and the headphone externally appear as one device, and the mobile phone does not know whether it is the base or the headphone that receive the message. At this time, the headphone responds to the message from the mobile phone, and the base does not respond to the message from the mobile phone. The headphone establishes a bidirectional BR/EDR Bluetooth connection to the mobile phone. Through a monitoring path 2 (a dotted-line path in FIG. 8), the base monitors information sent by the mobile phone to the headphone. The base also receives the connection information that is used for establishing bidirectional Bluetooth connection between the headphone and the mobile phone and synchronized through the bidirectional BR/EDR Bluetooth connection between the base and the headphone, thereby achieving the switching from the connection mode shown in FIG. 7 to the connection mode shown in FIG. 8. In fact, the mobile phone transmits data into the air in a form of a Bluetooth data packet, which can be received by any device within an actual effective range. Before this, a partner and the agent have completed pairing with the mobile phone. Both the partner and the agent have relevant pairing information, so only the partner and the agent can parse the data sent by the mobile phone to prevent an incorrect connection to an unpaired device and an information theft. In the connection mode shown in FIG. 7, the agent is the base. Through the bidirectional BR/EDR Bluetooth connection established between the base and the mobile phone, the base can obtain the data sent by the mobile phone. The headphone acts as the partner. Through the TrueWireless Mirroring technology, the MCSync technology, or another private monitoring technology, the agent is cloned at the headphone (in fact, the base is the agent, and all information of bidirectional Bluetooth connection between the agent and the mobile phone is replicated at the headphone). Information that the agent can receive can also be received by the partner. However, the partner cannot send information.

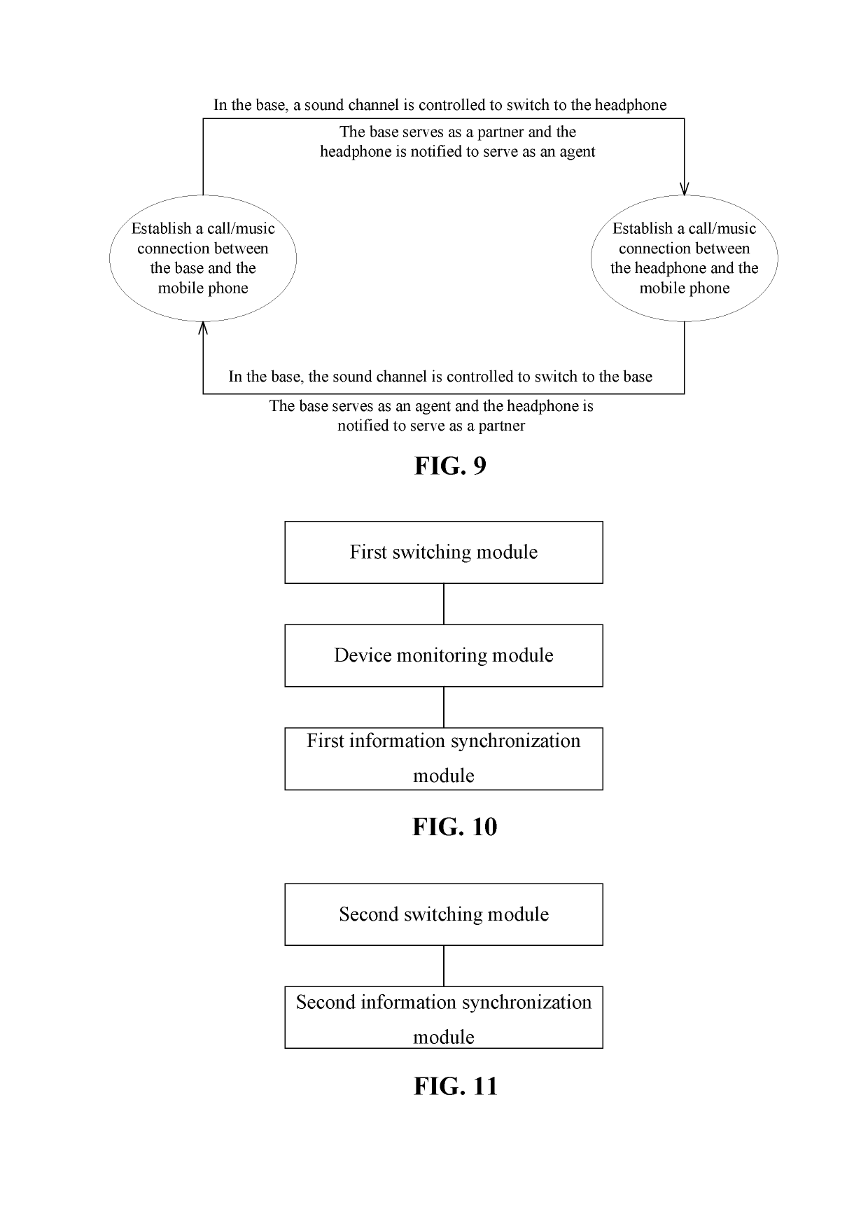

In some embodiments of the present disclosure, switching logic between different scenarios in a single-channel communication is shown in FIG. 9. When the base and the mobile phone establish a call or music connection, in the base, a sound channel is controlled to switch to the headphone. In this case, the base serves as the partner and the headphone is notified to serve as the agent, whereby the headphone and the mobile phone establish a call or music connection. When the headphone and the mobile phone establish the call or music connection, in the base, the sound channel is controlled to switch to the base. In this case, the base serves as the agent and the headphone is notified to serve as the partner, whereby the base and the mobile phone establish the call or music connection. The agent establishes an actual bidirectional Bluetooth connection with the mobile phone. The partner only monitors data exchanged between the agent and the mobile phone. The base and the headphone are connected through the BR/EDR connection, the BLE connection, or the combination of the BR/EDR connection and the BLE connection. The BR/EDR connection is used to synchronize role management information, channel selection information, and other link management information with the headphone. The BLE connection can be used to transmit audio control commands and data. The connections between the base and the headphone, between the base and the mobile phone, and between the headphone and the mobile phone are established through time-division multiplexing, which can minimize interference between the BR/EDR connection and the BLE connection.

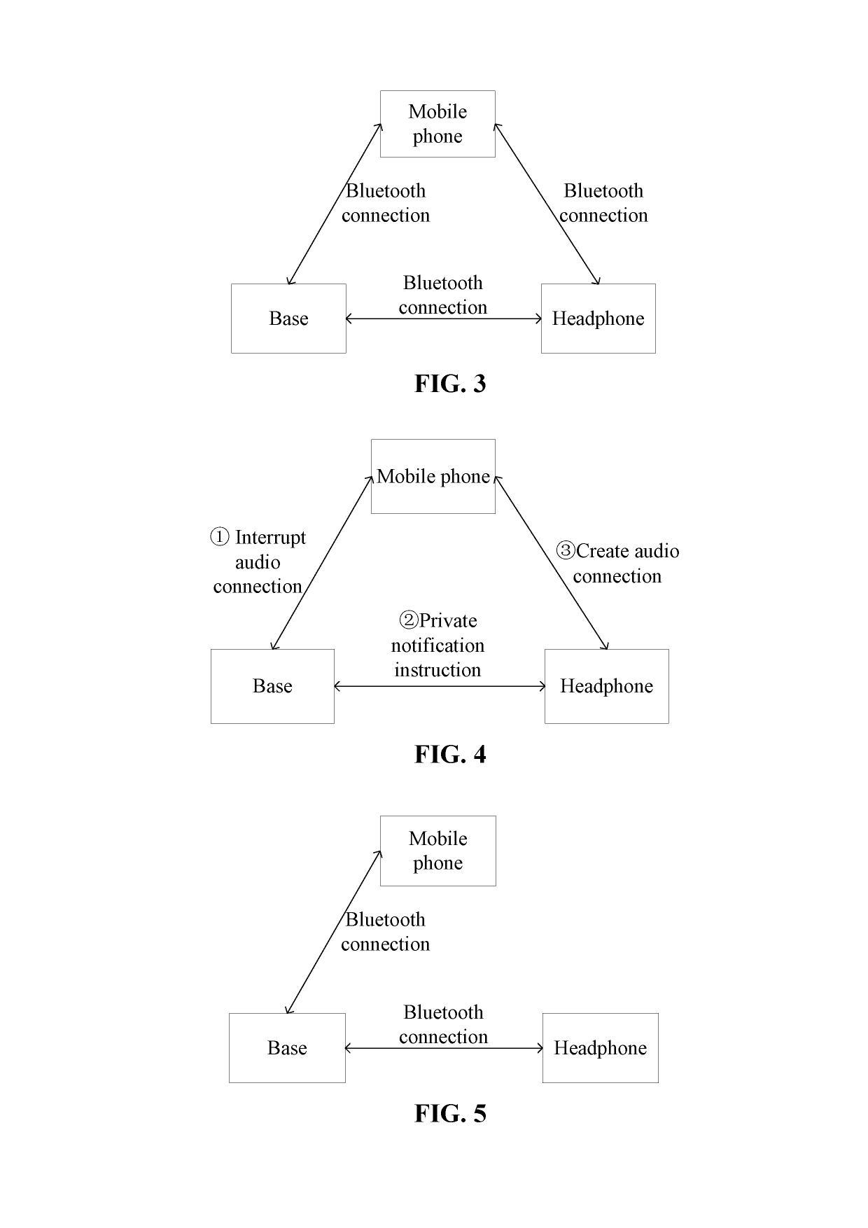

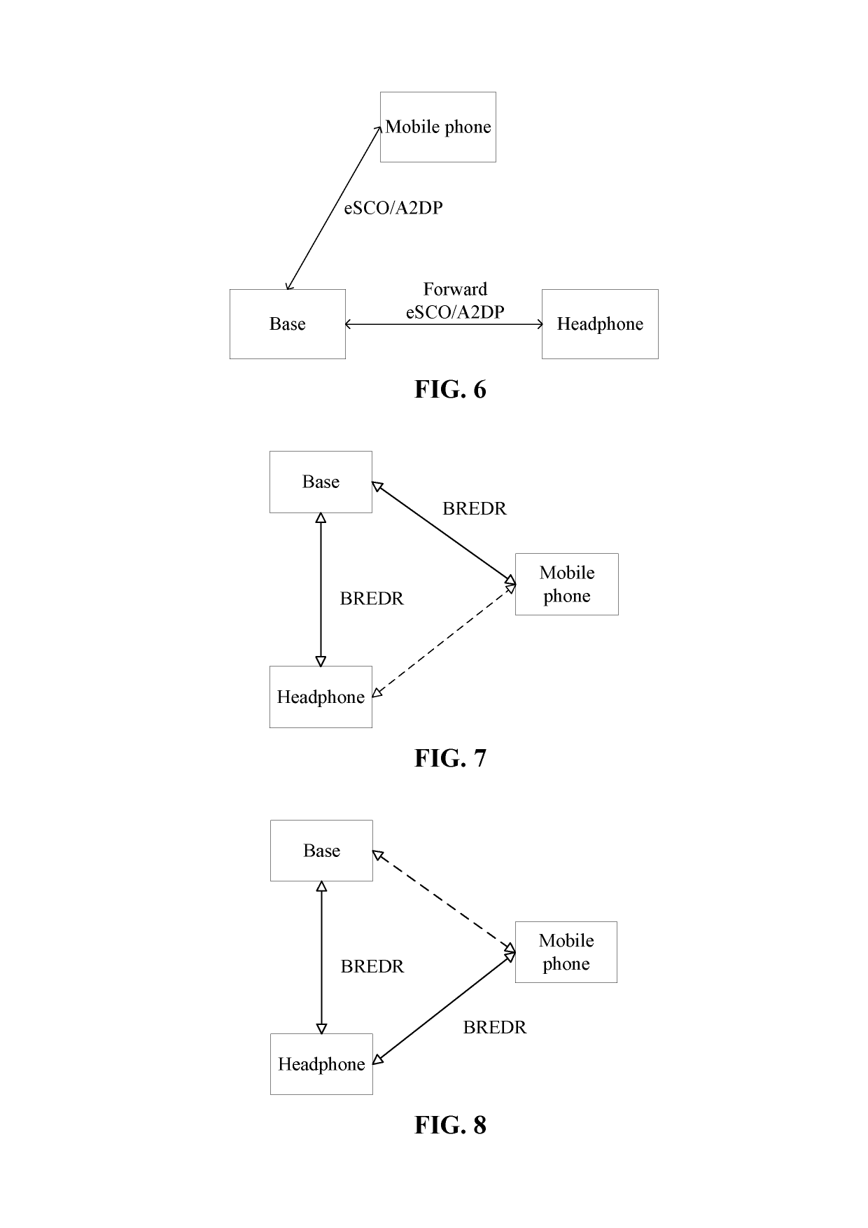

In some embodiments of the present disclosure, the target audio receiving device synchronizes the connection information for establishing the bidirectional Bluetooth connection between the target audio receiving device and the audio transmitting device to the non-target audio receiving device. The non-target audio receiving device monitors information transmitted by the audio transmitting device to the target audio receiving device (including the audio data and other data), and receives, through the bidirectional Bluetooth connection, the connection information for establishing bidirectional Bluetooth connection between the target audio receiving device and the audio transmitting device. The connection information is not all information between the target audio receiving device and the audio transmitting device, but only some useful information, such as frequency hopping information, and information about entering and exiting a sniff mode (the sniff mode is a power consumption management mode in a Bluetooth technology). Specific useful information needs to be defined based on a specific implementation of a connection switching scenario. The connection information received by the non-target audio receiving device is used to ensure synchronization between communication timeslots between the audio transmitting device and the audio receiving device. The information transmitted by the audio transmitting device to the target audio receiving device is used to ensure that a switched-to audio receiving device can immediately play correct audio when the audio channel is switched. In implementations of existing arts shown in FIG. 3 to FIG. 6, as shown in FIG. 3, a single Bluetooth chip is used on the base, and a Bluetooth connection is established between every two among the base, the headphone, and the mobile phone. When the mobile phone is in a call or playing music, if an eSCO/A2DP connection is oriented to the base and the user also needs to use the base, a current state will be maintained. If the eSCO/A2DP connection is oriented to the base, but the user needs to use the headphone, the base interrupts an eSCO/A2DP connection to the mobile phone (interrupts an audio connection), and then the base sends a private notification command to the headphone. After receiving the private notification command, the headphone actively establishes an eSCO/A2DP connection to the mobile phone (creates an audio connection), and as shown in FIG. 4, a current audio playback device is switched to the headphone. Conversely, if the eSCO/A2DP connection is initially oriented to the headphone, similar operations are performed. As shown in FIG. 5, a single Bluetooth chip is used on the base, and the base is connected to both the headphone and the mobile phone. When the mobile phone is in a call or playing music, if an eSCO/A2DP connection is oriented to the base and the user also needs to use the base, a current state will be maintained. If the eSCO/A2DP connection is oriented to the base, but the user needs to use the headphone, the base establishes an eSCO/A2DP connection to the headphone, and then the base forwards audio to the headphone (for the call, the base further forwards audio data received from the headphone to the mobile phone), and as shown in FIG. 6, a current audio playback device is switched to the headphone. Conversely, the headphone may also be connected to both the base and the mobile phone, and similar operations are performed. According to the switching methods shown in FIG. 3 and FIG. 4, the eSCO/A2DP connection (audio connection) needs to be established and interrupted during sound channel switching. Affected by a Bluetooth implementation of the mobile phone, problems such as a long switching delay are prone to occur. The switching methods shown in FIG. 5 and FIG. 6 have an extremely high requirement for the Bluetooth chip. Currently, the vast majority of Bluetooth chips on the market cannot achieve effective communication for two eSCO/A2DP links simultaneously. In this case, the base needs to forward the audio to the headphone, resulting in a significant delay between the audio played by the mobile phone and sound actually heard by the user (the delay is mainly time consumed by the base to forward the audio to the headphone). The audio switching methods shown in FIG. 7 and FIG. 8 neither require interrupting the audio connection, forwarding the instruction, and then establishing the audio connection only after receiving the instruction, nor do they require audio forwarding. In this solution, when audio playback needs to be switched from the base to the headphone, the communication between the headphone and the mobile phone can be synchronized to the base through monitoring and bidirectional Bluetooth connection between the headphone and the base, thereby realizing the seamless switching capability between the call and music among the base, the headphone and the mobile phone. Moreover, a single Bluetooth chip is used on the base, which can eliminate a delay generated in the audio switching process. In addition, since there is no need to interrupt the connection, forward the private notification instruction, and then establish the connection, there are no issues of abnormal disconnection or connection failure between the base and the mobile phone, or between the headphone and the mobile phone. Additionally, there is no need to forward the audio data or establish two audio communication connections on the base, so there will be no unstable connection, easy disconnection, or shortened communication distance during audio data forwarding, and thus no increase in data communication packet loss.

Another possible embodiment of the present disclosure provides an audio switching system, which includes at least two audio receiving devices and an audio transmitting device. A target audio receiving device is an audio receiving device that currently establishes bidirectional Bluetooth connection with the audio transmitting device, and a non-target audio receiving device is an audio receiving device that does not currently establish bidirectional Bluetooth connection with the audio transmitting device. The non-target audio receiving device monitors, by using a preset monitoring technology, audio data transmitted by the audio transmitting device to the target audio receiving device, and receives, through bidirectional Bluetooth connection, connection information for establishing bidirectional Bluetooth connection between the target audio receiving device and the audio transmitting device. With only one Bluetooth chip used on the non-target audio receiving device, a quantity of Bluetooth connections between the audio receiving device and the audio transmitting device is reduced. Without relying on compatibility of the audio transmitting device and performance of the Bluetooth chip, both the target audio receiving device and the non-target audio receiving device can receive data from the audio transmitting device simultaneously, and the connection information between the target audio receiving device and the audio transmitting device can be synchronized to the non-target audio receiving device. Thus, the at least two audio receiving devices can receive the data from the audio transmitting device simultaneously, achieving arbitrary switching and control of a call and music between the audio receiving device and the audio transmitting device. Communication timeslots of the audio receiving device and the audio transmitting device are synchronized, and there is no delay in a switching process. Meanwhile, since there is no need to interrupt a connection, forward a private notification instruction, and then establish a connection, there will be no disconnection abnormality or connection failure. Additionally, there is no need to forward the audio data or establish two audio communication connections, so there will be no unstable connection, easy disconnection, or shortened communication distance during audio data forwarding, and thus no increase in data communication packet loss.

FIG. 2 is a schematic flowchart of an audio switching method according to some embodiments of the present disclosure. The audio switching method is applicable to a target audio receiving device in an audio switching system, and includes the following steps:

S1: In response to detecting an audio switching operation, generate an audio switching instruction, and transmit the audio switching instruction to a non-target audio receiving device, whereby the non-target audio receiving device is changed to a new target audio receiving device and performs audio transmission with an audio transmitting device through bidirectional Bluetooth connection.

S2: Change to a new non-target audio receiving device, switch to a monitoring mode, and monitor, by using a preset monitoring technology, audio data transmitted by the audio transmitting device to the new target audio receiving device.

S3: Receive, through bidirectional Bluetooth connection, connection information for establishing bidirectional Bluetooth connection between the new target audio receiving device and the audio transmitting device.

In some implementations, when receiving the audio switching instruction transmitted by the non-target audio receiving device, the target audio receiving device is changed to the new non-target audio receiving device, switches to the monitoring mode, and monitors, by using the preset monitoring technology, the audio data transmitted by the audio transmitting device to the new target audio receiving device.

The connection information for establishing bidirectional Bluetooth connection between the new target audio receiving device and the audio transmitting device is received through bidirectional Bluetooth connection.

In response to detecting the audio switching operation, the non-target audio receiving device is changed to the new target audio receiving device, generates the audio switching instruction, and performs the audio transmission with the audio transmitting device through bidirectional Bluetooth connection.

In some implementations, the audio switching method includes at least two audio receiving devices and the audio transmitting device. When one audio receiving device establishes a bidirectional Bluetooth connection with another audio receiving device and the audio transmitting device, the target audio receiving device performs audio transmission with the audio transmitting device through bidirectional Bluetooth connection. The target audio receiving device is an audio receiving device that currently establishes bidirectional Bluetooth connection with the audio transmitting device. The non-target audio receiving device monitors, by using the preset monitoring technology, audio data transmitted by the audio transmitting device to the target audio receiving device, and receives, through bidirectional Bluetooth connection, connection information for establishing bidirectional Bluetooth connection between the target audio receiving device and the audio transmitting device, where the non-target audio receiving device is an audio receiving device that does not currently establish bidirectional Bluetooth connection with the audio transmitting device. In response to detecting the audio switching operation, the target audio receiving device generates the audio switching instruction, and transmits the audio switching instruction to the non-target audio receiving device, whereby the non-target audio receiving device is changed to the new target audio receiving device and performs the audio transmission with the audio transmitting device through bidirectional Bluetooth connection. In addition, the original target audio receiving device is changed to the new non-target audio receiving device, switches to the monitoring mode, monitors, by using the preset monitoring technology, the audio data transmitted by the audio transmitting device to the new target audio receiving device, and receives, through bidirectional Bluetooth connection, the connection information for establishing bidirectional Bluetooth connection between the new target audio receiving device and the audio transmitting device. When the target audio receiving device is a base, the non-target audio receiving device is a headphone, and the audio transmitting device is a mobile phone, in response to detecting the audio switching operation, the base generates the audio switching instruction and transmits the audio switching instruction to the headphone, whereby the headphone performs the audio transmission with the mobile phone through bidirectional Bluetooth connection. In addition, the base switches to the monitoring mode, monitors, by using the preset monitoring technology, the audio data transmitted by the mobile phone to the headphone, and receives, through bidirectional Bluetooth connection, the connection information for establishing bidirectional Bluetooth connection between the headphone and the mobile phone. When the target audio receiving device is the headphone, the non-target audio receiving device is the base, and the audio transmitting device is the mobile phone, in response to detecting the audio switching operation, the headphone generates the audio switching instruction and transmits the audio switching instruction to the base, whereby the base performs the audio transmission with the mobile phone through bidirectional Bluetooth connection. In addition, the headphone switches to the monitoring mode, monitors, by using the preset monitoring technology, the audio data transmitted by the mobile phone to the base, and receives, through bidirectional Bluetooth connection, the connection information for establishing bidirectional Bluetooth connection between the base and the mobile phone.

In some embodiments of the present disclosure, when receiving the audio switching instruction transmitted by the non-target audio receiving device, the target audio receiving device is changed to the new non-target audio receiving device, switches to the monitoring mode, and monitors, by using the preset monitoring technology, the audio data transmitted by the audio transmitting device to the new target audio receiving device. In addition, the original target audio receiving device receives, through bidirectional Bluetooth connection, the connection information for establishing bidirectional Bluetooth connection between the new target audio receiving device and the audio transmitting device. In response to detecting the audio switching operation, the non-target audio receiving device is changed to the new target audio receiving device, generates the audio switching instruction, and performs the audio transmission with the audio transmitting device through bidirectional Bluetooth connection. When the target audio receiving device is the base, the non-target audio receiving device is the headphone, and the audio transmitting device is the mobile phone, when receiving the audio switching instruction transmitted by the headphone, the base switches to the monitoring mode, monitors, by using the preset monitoring technology, the audio data transmitted by the mobile phone to the headphone. In addition, the base receives, through bidirectional Bluetooth connection, the connection information for establishing bidirectional Bluetooth connection between the headphone and the mobile phone. In some implementations, the base receives, through bidirectional Bluetooth connection established between the base and the headphone, the connection information that is used for establishing bidirectional Bluetooth connection between the headphone and the mobile phone and forwarded by the headphone. In response to detecting the audio switching operation, the headphone generates the audio switching instruction, and performs the audio transmission with the mobile phone through bidirectional Bluetooth connection. When the target audio receiving device is the headphone, the non-target audio receiving device is the base, and the audio transmitting device is the mobile phone, when receiving the audio switching instruction transmitted by the base, the headphone switches to the monitoring mode, and monitors, by using the preset monitoring technology, the audio data transmitted by the mobile phone to the base. In addition, the headphone receives, through bidirectional Bluetooth connection, the connection information for establishing bidirectional Bluetooth connection between the base and the mobile phone. In response to detecting the audio switching operation, the base generates the audio switching instruction, and performs the audio transmission with the mobile phone through bidirectional Bluetooth connection.

In some implementations, by using the preset monitoring technology, the non-target audio receiving device monitors the audio data transmitted by the audio transmitting device to the target audio receiving device. The preset monitoring technology includes a TrueWireless Mirroring technology, an MCSync technology, or another private monitoring technology. When the target audio receiving device is the base, the non-target audio receiving device is the headphone, and the audio transmitting device is the mobile phone, the headphone monitors, by using the preset monitoring technology, the audio data transmitted by the mobile phone to the base. When the target audio receiving device is the headphone, the non-target audio receiving device is the base, and the audio transmitting device is the mobile phone, the base monitors, by using the preset monitoring technology, the audio data transmitted by the mobile phone to the headphone.

In some implementations, the one audio receiving device establishes the bidirectional Bluetooth connection with the another audio receiving device and the audio transmitting device, and a connection mode of bidirectional Bluetooth connection includes any one and a combination of a BR/EDR connection (traditional Bluetooth connection) and a BLE connection. When the audio receiving devices are the base and the headphone, and the audio transmitting device is the mobile phone, a connection mode between the base and the mobile phone may be the BR/EDR connection, the BLE connection, or the combination of the BR/EDR connection and the BLE connection. A connection mode between the base and the headphone may be the BR/EDR connection, the BLE connection, or the combination of the BR/EDR connection and the BLE connection. A connection mode between the headphone and the mobile phone may be the BR/EDR connection, the BLE connection, or the combination of the BR/EDR connection and the BLE connection.

In some embodiments of the present disclosure, the audio transmitting device performs the audio transmission with the target audio receiving device through bidirectional Bluetooth connection, and the audio data transmitted by the audio transmitting device to the target audio receiving device is monitored by the non-target audio receiving device. The connection information for establishing bidirectional Bluetooth connection between the target audio receiving device and the audio transmitting device is transmitted to the non-target audio receiving device through bidirectional Bluetooth connection between the target audio receiving device and the non-target audio receiving device. When the original target audio receiving device is changed to the new non-target audio receiving device, and the original non-target audio receiving device is changed to the new target audio receiving device, the audio transmitting device performs audio data transmission with the new target audio receiving device through bidirectional Bluetooth connection. That is, data sent by the audio transmitting device is responded to by the new target audio receiving device. When the two audio receiving devices are the base and the headphone, and the audio transmitting device is the mobile phone, the mobile phone performs the audio transmission with the base through bidirectional Bluetooth connection, and the audio data transmitted by the mobile phone to the base is monitored by the headphone. When the switching operation occurs, the mobile phone performs the audio transmission with the headphone through bidirectional Bluetooth connection, and the audio data transmitted by the mobile phone to the headphone is monitored by the base.

The present disclosure further provides an audio switching method, which is applicable to an audio receiving device in an audio switching system. The audio receiving device is in either of two states of being a target audio receiving device and being a non-target audio receiving device. The target audio receiving device is an audio receiving device that currently establishes bidirectional Bluetooth connection to an audio transmitting device, and the non-target audio receiving device is an audio receiving device that does not currently establish bidirectional Bluetooth connection with the audio transmitting device. In response to detecting an audio switching operation of a user, the audio receiving device switches its state to the other state different from the current state of being the target audio receiving device or the non-target audio receiving device. The non-target audio receiving device monitors, by using a preset monitoring technology, audio data transmitted by the audio transmitting device to the target audio receiving device, and receives, through bidirectional Bluetooth connection, connection information for establishing bidirectional Bluetooth connection between the target audio receiving device and the audio transmitting device. With only one Bluetooth chip used on the non-target audio receiving device, a quantity of Bluetooth connections between the audio receiving device and the audio transmitting device is reduced. Without relying on compatibility of the audio transmitting device and performance of the Bluetooth chip, both the target audio receiving device and the non-target audio receiving device can receive data from the audio transmitting device simultaneously, and the connection information between the target audio receiving device and the audio transmitting device can be synchronized to the non-target audio receiving device. Thus, at least two audio receiving devices can receive the data from the audio transmitting device simultaneously, achieving arbitrary switching and control of a call and music between the audio receiving device and the audio transmitting device, and eliminating a delay in a switching process. Meanwhile, since there is no need to interrupt a connection, forward a private notification instruction, and then establish a connection, there will be no disconnection abnormality or connection failure. Additionally, there is no need to forward the audio data or establish two audio communication connections, so there will be no unstable connection, easy disconnection, or shortened communication distance during audio data forwarding, and thus no increase in data communication packet loss.

FIG. 10 is a schematic structural diagram of an audio switching apparatus according to another possible embodiment of the present disclosure. The audio switching apparatus is applicable to a target audio receiving device in an audio switching system, and includes:

a first switching module configured to: in response to detecting an audio switching operation, generate an audio switching instruction, and transmit the audio switching instruction to a non-target audio receiving device, whereby the non-target audio receiving device is changed to a new target audio receiving device and performs audio transmission with an audio transmitting device through bidirectional Bluetooth connection; a device monitoring module configured to change to a new non-target audio receiving device, switch to a monitoring mode, and monitor, by using a preset monitoring technology, audio data transmitted by the audio transmitting device to the new target audio receiving device; and a first information synchronization module configured to receive, through bidirectional Bluetooth connection, connection information for establishing bidirectional Bluetooth connection between the new target audio receiving device and the audio transmitting device.

In some embodiments of the present disclosure, referring to FIG. 11, the audio switching apparatus further includes: a second switching module configured to: when receiving the audio switching instruction transmitted by the non-target audio receiving device, change to the new non-target audio receiving device, switch to the monitoring mode, and monitor, by using the preset monitoring technology, the audio data transmitted by the audio transmitting device to the new target audio receiving device; and a second information synchronization module configured to receive, through bidirectional Bluetooth connection, the connection information for establishing bidirectional Bluetooth connection between the new target audio receiving device and the audio transmitting device. In response to detecting the audio switching operation, the non-target audio receiving device is changed to the new target audio receiving device, generates the audio switching instruction, and performs the audio transmission with the audio transmitting device through bidirectional Bluetooth connection.

In some embodiments of the present disclosure, the first switching module, the device monitoring module, the first information synchronization module, the second switching module, and the second information synchronization module each may be one or more processors, controllers, or chips that each have a communication interface, can realize a communication protocol, and may further include a memory, a related interface and system transmission bus, and the like if necessary. The processor, controller, or chip executes program-related code to realize a corresponding function. In an alternative solution, the first switching module, the device monitoring module, the first information synchronization module, the second switching module, and the second information synchronization module share an integrated chip or share devices such as a processor, a controller, and a memory. The shared processor, controller, or chip executes program-related code to implement a corresponding function.

In some embodiments of the present disclosure, in response to detecting the audio switching operation, the target audio receiving device in the audio switching system generates the audio switching instruction through the first switching module, and transmits the audio switching instruction to the non-target audio receiving device, whereby the non-target audio receiving device is changed to the new target audio receiving device and performs the audio transmission with the audio transmitting device through bidirectional Bluetooth connection. Then, the target audio receiving device is changed to the new non-target audio receiving device through the device monitoring module, switches to the monitoring mode, and monitors, by using the preset monitoring technology, the audio data transmitted by the audio transmitting device to the new target audio receiving device. Finally, the first information synchronization module receives, through bidirectional Bluetooth connection, the connection information for establishing bidirectional Bluetooth connection between the new target audio receiving device and the audio transmitting device. According to this embodiment, since there is no need to interrupt a connection, forward a private notification instruction, and then establish a connection, there will be no disconnection abnormality or connection failure. Additionally, there is no need to forward the audio data or establish two audio communication connections, so there will be no unstable connection, easy disconnection, or shortened communication distance during audio data forwarding, and thus no increase in data communication packet loss. Meanwhile, the target audio receiving device and the non-target audio receiving device can simultaneously receive data sent by the audio transmitting device, and the connection information between the target audio receiving device and the audio transmitting device can be synchronized to the non-target audio receiving device. In this way, at least two audio receiving devices can simultaneously receive the data from the audio transmitting device, achieving arbitrary switching and control of a call and music between the audio receiving device and the audio transmitting device. Communication timeslots of the audio receiving device and the audio transmitting device are synchronized, and there is no delay in a switching process.

The above are the implementations of the present disclosure. It should be noted that improvements and modifications can be made by those of ordinary skill in the art without departing from the principles of the present disclosure, and these improvements and modifications should also be considered as falling within the protection scope of the present disclosure.

1. An audio switching system, comprising: at least two audio receiving devices and an audio transmitting device, wherein
In a case that an audio receiving device establishes bidirectional Bluetooth connection with another audio receiving device and the audio transmitting device, the audio receiving device is in either of two states of being a target audio receiving device and being a non-target audio receiving device;
the target audio receiving device performs audio transmission with the audio transmitting device through bidirectional Bluetooth connection, wherein the target audio receiving device is an audio receiving device that currently establishes bidirectional Bluetooth connection with the audio transmitting device;
the non-target audio receiving device monitors, by using a preset monitoring technology, audio data transmitted by the audio transmitting device to the target audio receiving device, and receives, through bidirectional Bluetooth connection, connection information for establishing bidirectional Bluetooth connection between the target audio receiving device and the audio transmitting device, wherein the non-target audio receiving device is an audio receiving device that does not currently establish bidirectional Bluetooth connection with the audio transmitting device; and
in response to detecting an audio switching operation, the audio receiving device switches a state of the audio receiving device to the other state different from the current state of being the target audio receiving device or the non-target audio receiving device.

2. The audio switching system according to claim 1, wherein that in response to detecting an audio switching operation, the audio receiving device switches a state of the audio receiving device to the other state different from the current state of being the target audio receiving device or the non-target audio receiving device comprises:
generating an audio switching instruction, and transmitting the audio switching instruction to the non-target audio receiving device, whereby the non-target audio receiving device is changed to a new target audio receiving device and performs audio transmission with the audio transmitting device through bidirectional Bluetooth connection;
changing the target audio receiving device to a new non-target audio receiving device, switching to a monitoring mode, and monitoring, by using the preset monitoring technology, audio data transmitted by the audio transmitting device to the new target audio receiving device; and
receiving, through bidirectional Bluetooth connection, connection information for establishing bidirectional Bluetooth connection between the new target audio receiving device and the audio transmitting device.

3. The audio switching system according to claim 1, wherein in a case that the audio receiving device establishes bidirectional Bluetooth connection with the another audio receiving device and the audio transmitting device:
in response to receiving an audio switching instruction transmitted by the non-target audio receiving device, the target audio receiving device is further changed to a new non-target audio receiving device, switches to a monitoring mode, and monitors, by using the preset monitoring technology, audio data transmitted by the audio transmitting device to a new target audio receiving device; and
receives, through bidirectional Bluetooth connection, connection information for establishing bidirectional Bluetooth connection between the new target audio receiving device and the audio transmitting device; wherein
in response to detecting the audio switching operation, the non-target audio receiving device is changed to the new target audio receiving device, generates the audio switching instruction, and performs audio transmission with the audio transmitting device through bidirectional Bluetooth connection.

4. The audio switching system according to claim 1, wherein the at least two audio receiving devices are respectively a base and a headphone; and the audio transmitting device is a mobile phone.

5. The audio switching system according to claim 1, wherein the preset monitoring technology comprises a TrueWireless Mirroring technology or a multi-channel synchronization (MCSync) technology.

6. The audio switching system according to claim 1, wherein a connection mode of bidirectional Bluetooth connection comprises any one and a combination of a basic rate/enhanced data rate (BR/EDR) connection and a Bluetooth low energy (BLE) connection.

7. An audio switching method, applicable to a target audio receiving device in the audio switching system according to claim 1, wherein
the audio switching method comprises:
in response to detecting an audio switching operation, generating an audio switching instruction, and transmitting the audio switching instruction to a non-target audio receiving device, whereby the non-target audio receiving device is changed to a new target audio receiving device and performs audio transmission with an audio transmitting device through bidirectional Bluetooth connection;
changing to a new non-target audio receiving device, switching to a monitoring mode, and monitoring, by using a preset monitoring technology, audio data transmitted by the audio transmitting device to the new target audio receiving device; and
receiving, through bidirectional Bluetooth connection, connection information for establishing bidirectional Bluetooth connection between the new target audio receiving device and the audio transmitting device.

8. The audio switching method according to claim 7, further comprising:
in response to receiving the audio switching instruction transmitted by the non-target audio receiving device, changing to the new non-target audio receiving device, switching to the monitoring mode, and monitoring, by using the preset monitoring technology, the audio data transmitted by the audio transmitting device to the new target audio receiving device; and
receiving, through bidirectional Bluetooth connection, connection information for establishing bidirectional Bluetooth connection between the new target audio receiving device and the audio transmitting device; wherein
in response to detecting the audio switching operation, the non-target audio receiving device is changed to the new target audio receiving device, generates the audio switching instruction, and performs the audio transmission with the audio transmitting device through bidirectional Bluetooth connection.

9. The audio switching method according to claim 7, wherein the at least two audio receiving devices are respectively a base and a headphone; and the audio transmitting device is a mobile phone.

10. The audio switching method according to claim 7, wherein the preset monitoring technology comprises a TrueWireless Mirroring technology or an MCSync technology.

11. The audio switching method according to claim 7, wherein a connection mode of bidirectional Bluetooth connection comprises any one and a combination of a BR/EDR connection and a BLE connection.

12. An audio switching method, applicable to a target audio receiving device in the audio switching system according to claim 2, wherein
the audio switching method comprises:
in response to detecting an audio switching operation, generating an audio switching instruction, and transmitting the audio switching instruction to a non-target audio receiving device, whereby the non-target audio receiving device is changed to a new target audio receiving device and performs audio transmission with an audio transmitting device through bidirectional Bluetooth connection;
changing to a new non-target audio receiving device, switching to a monitoring mode, and monitoring, by using a preset monitoring technology, audio data transmitted by the audio transmitting device to the new target audio receiving device; and
receiving, through bidirectional Bluetooth connection, connection information for establishing bidirectional Bluetooth connection between the new target audio receiving device and the audio transmitting device.

13. The audio switching method according to claim 12, further comprising:
in response to receiving the audio switching instruction transmitted by the non-target audio receiving device, changing to the new non-target audio receiving device, switching to the monitoring mode, and monitoring, by using the preset monitoring technology, the audio data transmitted by the audio transmitting device to the new target audio receiving device; and
receiving, through bidirectional Bluetooth connection, connection information for establishing bidirectional Bluetooth connection between the new target audio receiving device and the audio transmitting device; wherein
in response to detecting the audio switching operation, the non-target audio receiving device is changed to the new target audio receiving device, generates the audio switching instruction, and performs the audio transmission with the audio transmitting device through bidirectional Bluetooth connection.

14. The audio switching method according to claim 12, wherein the at least two audio receiving devices are respectively a base and a headphone; and the audio transmitting device is a mobile phone.

15. The audio switching method according to claim 12, wherein the preset monitoring technology comprises a TrueWireless Mirroring technology or an MCSync technology.

16. The audio switching method according to claim 12, wherein a connection mode of bidirectional Bluetooth connection comprises any one and a combination of a BR/EDR connection and a BLE connection.

17. An audio switching method, applicable to a target audio receiving device in the audio switching system according to claim 3, wherein
the audio switching method comprises:
in response to detecting an audio switching operation, generating an audio switching instruction, and transmitting the audio switching instruction to a non-target audio receiving device, whereby the non-target audio receiving device is changed to a new target audio receiving device and performs audio transmission with an audio transmitting device through bidirectional Bluetooth connection;
changing to a new non-target audio receiving device, switching to a monitoring mode, and monitoring, by using a preset monitoring technology, audio data transmitted by the audio transmitting device to the new target audio receiving device; and
receiving, through bidirectional Bluetooth connection, connection information for establishing bidirectional Bluetooth connection between the new target audio receiving device and the audio transmitting device.

18. An audio switching method, applicable to a target audio receiving device in the audio switching system according to claim 4, wherein
the audio switching method comprises:
in response to detecting an audio switching operation, generating an audio switching instruction, and transmitting the audio switching instruction to a non-target audio receiving device, whereby the non-target audio receiving device is changed to a new target audio receiving device and performs audio transmission with an audio transmitting device through bidirectional Bluetooth connection;
changing to a new non-target audio receiving device, switching to a monitoring mode, and monitoring, by using a preset monitoring technology, audio data transmitted by the audio transmitting device to the new target audio receiving device; and
receiving, through bidirectional Bluetooth connection, connection information for establishing bidirectional Bluetooth connection between the new target audio receiving device and the audio transmitting device.

19. An audio switching method, applicable to a target audio receiving device in the audio switching system according to claim 5, wherein
the audio switching method comprises:
in response to detecting an audio switching operation, generating an audio switching instruction, and transmitting the audio switching instruction to a non-target audio receiving device, whereby the non-target audio receiving device is changed to a new target audio receiving device and performs audio transmission with an audio transmitting device through bidirectional Bluetooth connection;
changing to a new non-target audio receiving device, switching to a monitoring mode, and monitoring, by using a preset monitoring technology, audio data transmitted by the audio transmitting device to the new target audio receiving device; and
receiving, through bidirectional Bluetooth connection, connection information for establishing bidirectional Bluetooth connection between the new target audio receiving device and the audio transmitting device.

20. An audio switching apparatus, applicable to a target audio receiving device in the audio switching system according to claim 1, comprising:
a first switching module configured to: in response to detecting an audio switching operation, generate an audio switching instruction, and transmit the audio switching instruction to a non-target audio receiving device, whereby the non-target audio receiving device is changed to a new target audio receiving device and performs audio transmission with an audio transmitting device through bidirectional Bluetooth connection;
a device monitoring module configured to change to a new non-target audio receiving device, switch to a monitoring mode, and monitor, by using a preset monitoring technology, audio data transmitted by the audio transmitting device to the new target audio receiving device; and
a first information synchronization module configured to receive, through bidirectional Bluetooth connection, connection information for establishing bidirectional Bluetooth connection between the new target audio receiving device and the audio transmitting device.
